(19) United States
(12) Patent Application Publication
(10) Pub. No.: US 2009/0106730 A1
(43) Pub. Date: Apr. 23, 2009

(54) Predictive cost based scheduling in a distributed software build

(75) Inventor: Kieran P. Mockford, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/977,124

(22) Filed: Oct. 23, 2007

(51) Int. Cl. G06F 9/44

(52) U.S. Cl. 717/101

(57) ABSTRACT

Various technologies and techniques are disclosed for predicting costs of build phases and using the predicted costs to improve distributed build scheduling. Build data is accessed to analyze future build steps. Predicted costs are calculated for components of a later phase of the build process using the build data. The predicted costs of the components are made available to a scheduler so the scheduler can use the predicted costs to help determine proper load balancing for the later phase of the build process. For example, the scheduler can access the predicted costs from a data store. A load balancing determination is made by the scheduler for how to allocate the upcoming phase of the build process among build machines based at least in part upon the predicted costs of components. The build process for the later phase is distributed across build machines based upon the load balancing determination.

### BACKGROUND

Software applications are created using one or more software development programs. Developers write source code to implement the desired functionality of a given software application. Once the source code is written, the software application is then compiled into the executable files that will run on an end user's computer. In large software applications, there can be hundreds or thousands of different source code files and projects that need to be compiled. For such large software applications, it is often desirable to distribute the build process across multiple build machines. These build machines each participate by performing a designated portion of the build process.

The build process is typically managed by a build scheduler. The build scheduler is responsible for determining which parts of the build process should be assigned to each build machine. Some existing build schedulers analyze historical data associated with prior builds to determine how to best balance the work load among the build machines.

### SUMMARY

Various technologies and techniques are disclosed for predicting costs of build phases and using the predicted costs to improve distributed build scheduling. Build data is accessed to analyze future build steps of a build process. Predicted costs are calculated for components of a later phase of the build process using the build data. The predicted costs of the components are made available to a scheduler so the scheduler can use the predicted costs to help determine proper load balancing for the later phase of the build process. For example, the scheduler can access the predicted costs from a data store. A load balancing determination is made by the scheduler for how to allocate the upcoming phase of the build process among build machines based at least in part upon the predicted costs of components. The build process for the later phase is distributed across build machines based upon the load balancing determination.

In one implementation, a method for calculating and communicating future cost predictions to a scheduler for multiple phases of a distributed build process is described. During a first phase of a distributed build process, predicted costs are calculated for components of a second phase of the distributed build process. The predicted costs of the components of the second phase are made available to a scheduler for use by the scheduler in scheduling the second phase of the distributed build process. During the second phase of the distributed build process, predicted costs are calculated for components of a third phase of the distributed build process. The predicted costs of components of the third phase are made available to the scheduler for use by the scheduler in scheduling the third phase of the distributed build process.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a predictive cost based scheduling system for a distributed software build process of one implementation.

FIG. 2 is a diagrammatic view of a computer system of one implementation.

FIG. 3 is a diagrammatic view of a distributed software build across multiple build machines.

FIG. 4 is a high-level process flow diagram for one implementation of the system of FIG. 1.

FIG. 5 is a diagrammatic view of a cost prediction process that communicates predictions to a scheduler during different phases of a build process.

FIG. 6 is a process flow diagram for one implementation illustrating the stages involved in calculating predicted costs for a particular phase of a build.

FIG. 7 is a process flow diagram for another implementation illustrating the stages involved in predictive cost based scheduling.

FIG. 8 is a diagrammatic view of a more detailed cost based scheduling system of one implementation.

### DETAILED DESCRIPTION

The technologies and techniques herein may be described in the general context as an application that manages and/or interfaces with distributed software builds, but the technologies and techniques also serve other purposes in addition to these. In one implementation, one or more of the techniques described herein can be implemented as features within a software development program such as MICROSOFT® VISUAL STUDIO®, or from any other type of program or service that generates predicted costs for future phases of a distributed build and/or uses the predicted costs for scheduling the distributed build.

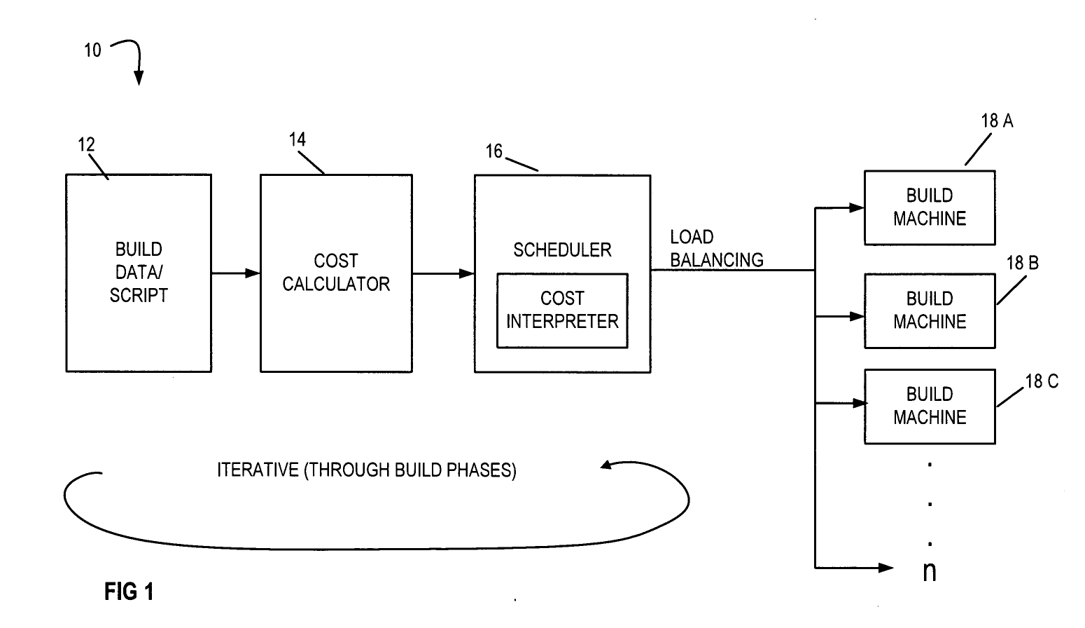

FIG. 1 is a diagrammatic view of a predictive cost based scheduling system 10 for a distributed software build process of one implementation. Build data and/or a build script 12 are accessed by a cost calculator 14 to calculate predicted costs for components that are contained in a particular upcoming phase of the build process. The term “component” as used herein is meant to include a collection of files or other resources that form a logical unit, such as those that are used to generate an executable file or dynamic link library. The term “predicted cost” as used herein is meant to include an estimate of how much will have to be expended in build resources to build a given component. The term “phase” as used herein is meant to include a clearly distinguishable period or stage in an overall process. In the case of a distributed software build, the term phase can be tied directly to the phases of the build process (such as prepare, generate, compile, and link), or to some smaller or larger set or sub-set of those phases.

The cost calculator 14 makes the predicted costs available to the scheduler 16, such as by storing the predicted costs in a data store that is accessible by the scheduler 16, or by directly sending the costs to the scheduler 16. The scheduler 16 contains a cost interpreter that helps analyze the predicted costs of components in the particular upcoming phase of the build process. The scheduler, with the aid of the cost interpreter, then performs load balancing to determine how to distribute the building of the components among the different build machines (18 A, 18 B, 18 C, etc.), and then actually distributes the building of the components to the build machines (18 A, 18 B, 18 C, etc.) accordingly. These stages are described in greater detail in the figures that follow.

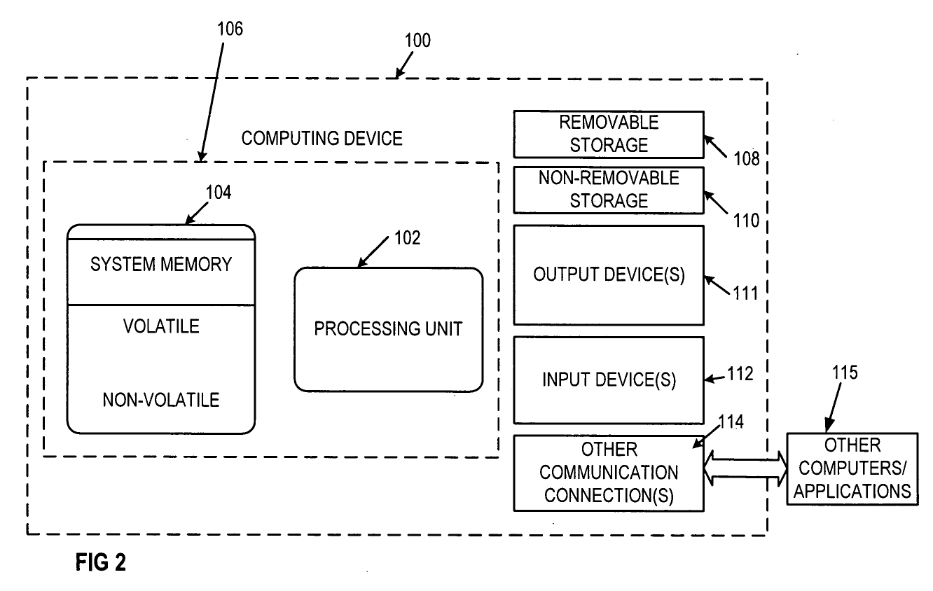

As shown in FIG. 2, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 2 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 2 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here.

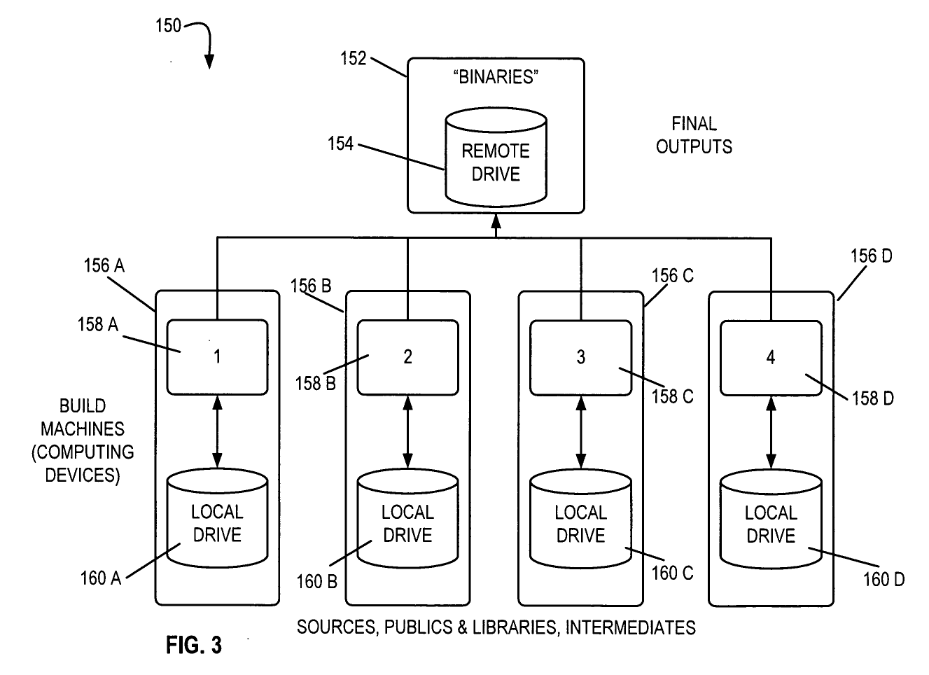

FIG. 3 is a diagrammatic view 150 of a distributed software build across multiple build machines. During the distributed build process, various build machines (156 A, 156 B, 156 C, and 156 D) contribute a respective portion of the build. For example, the build process (158 A, 158 B, 158 C, and 158 D) on each of these build machines (156 A, 156 B, 156 C, and 156 D) generates various source files, public and library files, and/or intermediate files on the respective local drives (160 A, 160 B, 160 C, and 160 D). In one implementation, the final binaries 152 are then copied to a remote drive 154 when the process completes.

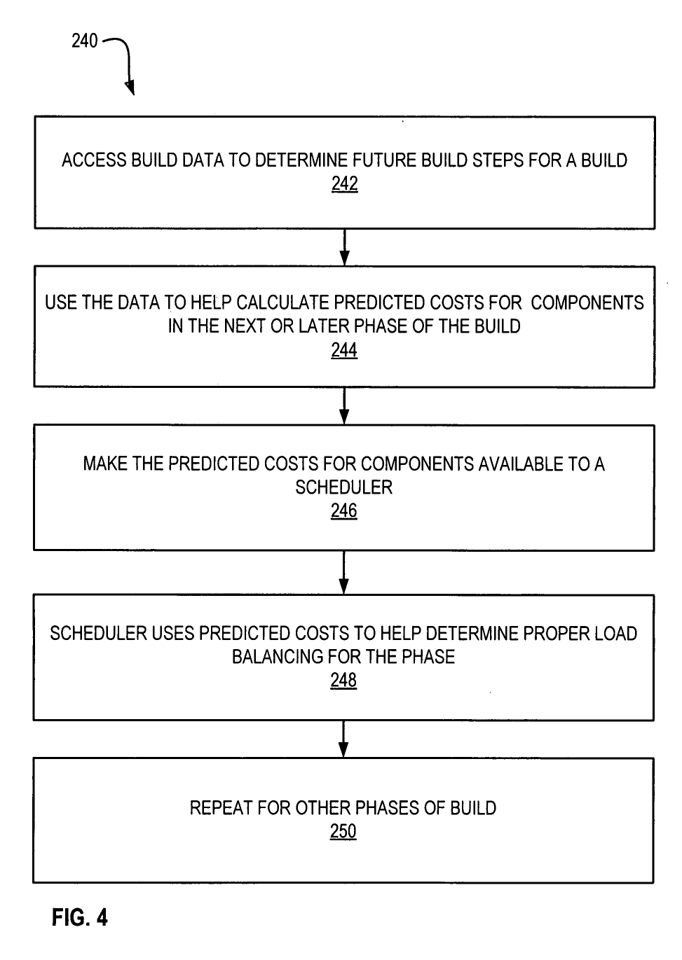

Turning now to FIGS. 4-8 with continued reference to FIGS. 1-3, the stages for implementing one or more implementations of predictive cost based scheduling system 10 are described in further detail. In some implementations, the processes of FIG. 4-8 are at least partially implemented in the operating logic of computing device 100.

FIG. 4 is a high level process flow diagram 240. Build data is accessed to determine future build steps for a build process (stage 242). In one implementation, the build data is accessed from a build script that contains details about the overall build process, as well as the detailed components and the files they contain. The build data is used to help calculate the predicted costs for components of a next or later phase of the build process (stage 244). The calculated costs are made available to a scheduler (stage 246), such as by storing the costs in a data store that is accessible by the scheduler, or by sending the costs directly to the scheduler. The scheduler then uses the cost to help determine proper load balancing for the phase (stage 248). The stages are repeated for the other phases of the build (stage 250).

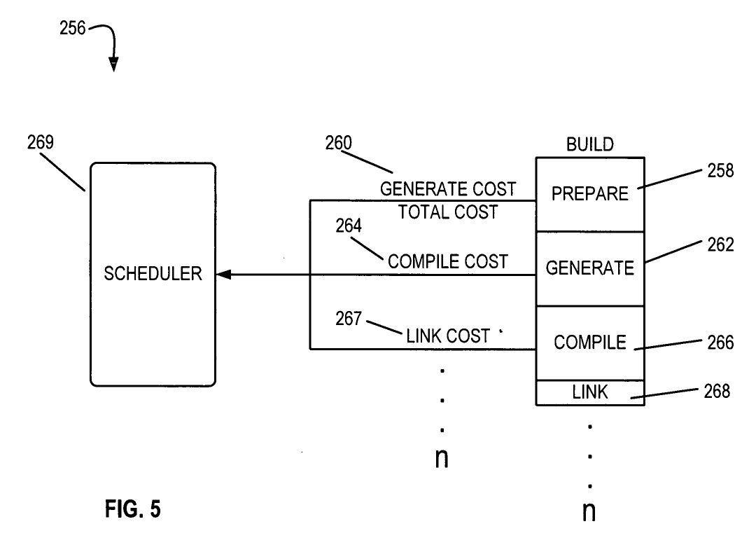

Turning now to FIGS. 5-8, more detailed descriptions will be provided to illustrate these concepts in further detail. Beginning with FIG. 5, a diagrammatic view of a cost prediction process 256 that communicates predictions to a scheduler 269 during different phases of a build is shown. In the example build process shown, there are four phases to the build: a prepare phase 258, a generate phase 262, a compile phase 266, and a link phase 268. These are the phases that many software builds go through in order to generate the resulting binary files that can be distributed to an end user's computer. However, it will be appreciated that other software build processes may have fewer, additional, and/or different build phases than these shown. For example, in the case of an interpreted application, such as a web application that uses script files, some of these stages are not used at all during a build process.

Returning to the example of FIG. 5, during the prepare phase 258, predicted costs 260 are determined for what the components of the generate phase 262 will take to complete. The predicted costs 260 of the generate phase 262 are then made available to the scheduler 269 for use in starting the generate phase 262. While the generate phase 262 is executing, predicted costs 264 are determined for what the components of the compile phase 266 will take to complete. The predicted costs 264 of the compile phase 266 are then made available to the scheduler 269 for use in starting the compile phase 266. While the compile phase 266 is executing, predicted costs 267 are determined for what the components of the link phase 268 will take to complete. The predicted costs 267 are then made available to the scheduler 269 for use in starting the link phase 268.

Other phases can also be included in the build process, as indicated on FIG. 5. One non-limiting example of another phase that can be included is a setup distribution phase that comes after linking to create the setup programs for performing the software installation. Other variations for calculating the predicted costs using future data and then making the predictions available to the scheduler for use in scheduling later phases can also be used instead of or in addition to those shown in FIG. 5 and/or the other figures herein.

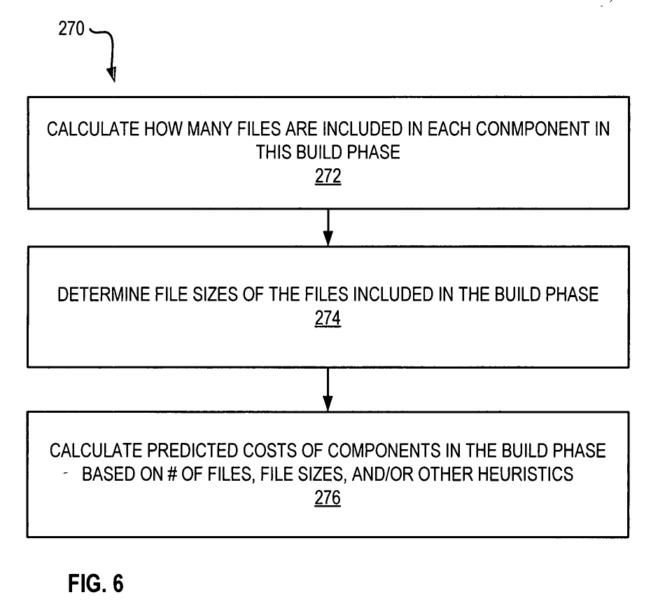

Turning now to FIG. 6, a process flow diagram 270 is shown that illustrates one implementation of the stages involved in calculating predicted costs for a particular phase of a build process. The cost calculator calculates how many files are included in each component in this build phase (stage 272). The cost calculator alternatively or additionally determines the file sizes of the files included in this build phase (stage 274). Predicted costs are then calculated for the components in this phase using the number of files, file sizes, and/or other heuristics (such as category analysis, file type analysis, etc. as described later) (stage 276). Some examples will now be used to further illustrate how the cost calculator can generate the predicted costs. For example, suppose that one component (Component A) has 300 files and another component (Component B) has 3 files. An example of a simplistic cost determination would be to just assign a predicted cost of 300 to Component A and 3 to Component B, which corresponds directly to the number of files each component contains. However, the file size of all the files that will be used to build Component A could also be useful in determining how much work will be involved in processing the build for Component A. Likewise for component B. Thus, the number of files and the size of the files could also be used in combination in calculating the predicted cost for each component.

Other information could also be useful in predicting how much a given component will take in resources to build. For example, the category of a given file can also be useful, such as a category that is CPU intensive as opposed to disk intensive. For example, the processing of files in the compiling phase may be more CPU intensive, while the processing of files in the linking phase may be more disk intensive. In one implementation, this category information can be used instead of or in addition to the number of files and/or the size of the files in calculating the predicted costs for each component. In one implementation, the type of files is filtered so that the predicted costs for the phase are generated for just those file types. For example, the predicted costs of components in the linking phase can be calculated by analyzing just the file types that are core to the linking process (and not other file types that may also be used in the linking process).

In one implementation, the cost calculator can be included as part of the build program itself. For example, in such an implementation, the calculation of the predicted costs for a future phase can be included as part of the build for a prior phase.

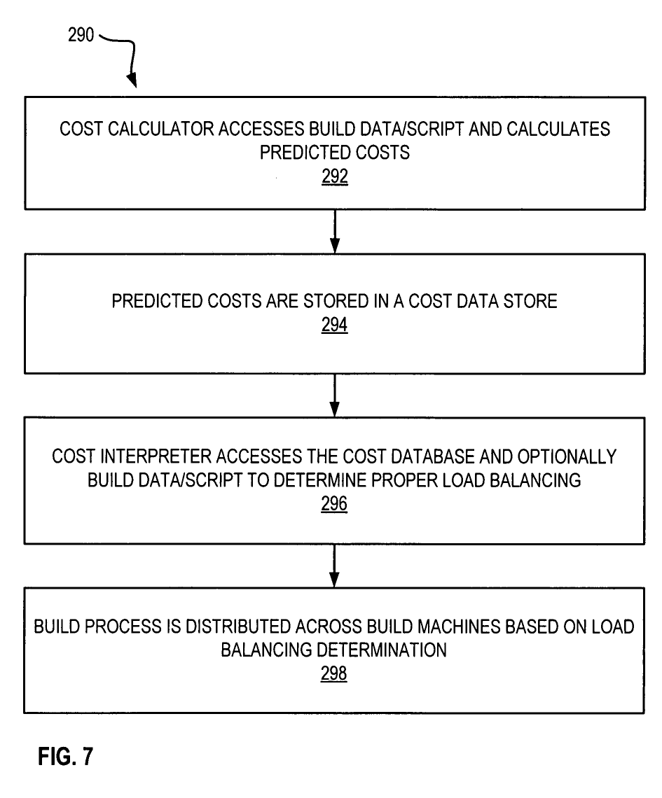

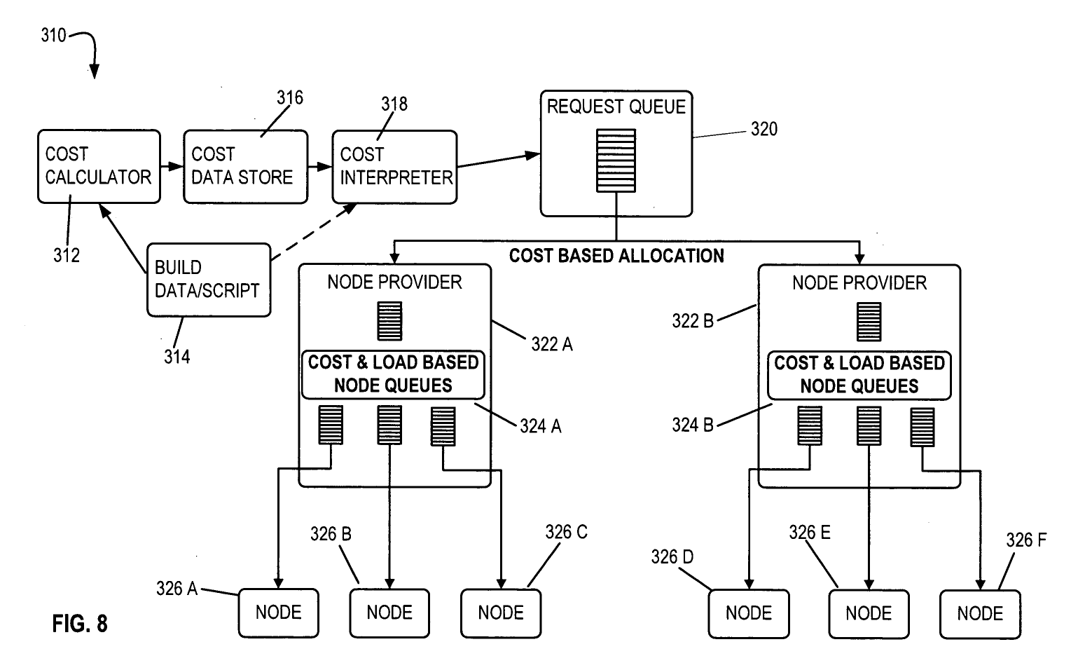

Turning now to FIG. 7, a process flow diagram 290 is shown that illustrates the stages involved in another implementation of a predictive cost based scheduling system that uses a data store to store the predicted costs. A cost calculator accesses build data and/or one or more build scripts and calculates the predicted costs of components in the particular build phase (stage 292). As noted earlier, the cost calculator can be included as part of the build program itself, or in a separate program. The predicted costs of the components are then stored in a cost data store (stage 294). A cost interpreter accesses the cost data store and optionally accesses the build data/script to determine proper load balancing (stage 296). The build process is distributed across the build machines based on the load balancing determination (stage 298). FIG. 8 provides further details on this process.

FIG. 8 is a diagrammatic view 310 of a more detailed cost based scheduling system 310 of one implementation. The primary components of scheduling system 310 include a cost calculator 312, build data/script 314, cost data store 316, cost interpreter 318, request queue 320, and node providers (322 A and 322 B), respectively. The cost calculator 312 is responsible for calculating the predicted costs of components in the respective phase of the build, as described in FIGS. 4-7 herein. Those costs are then stored in data store 316 for access by the cost interpreter 318 managed by the scheduler. The scheduler uses the predicted costs in scheduling the creation of the components for the respective build phase based upon one of a variety of load balancing techniques. For example, the component that will take the longest to build is started first on one build machine, while the other components can be distributed evenly among other build machines. Numerous other load balancing techniques can be used.

In one implementation, component creation requests for this phase are loaded into the request queue, where they are distributed to the proper node providers (322 A and 322 B). Node providers are the means by which the build program aggregates the nodes that appear on a single machine. In one implementation, the scheduler communicates with the node providers (322 A or 322 B), addressing a particular node. The node providers (322 A and 322 B) then distribute the actual work to the respective cost and load based node queues (324 A and 324 B) where the work associated with the building of the respective components are assigned to their respective nodes (326 A, 326 B, 326 C, 326 D, 326 E, and 326 F), as appropriate. In other words, each node actually executes a respective part of the build process. For example, in the case of a component that requires compilation, the actual processing of the compile phase of the build process is performed by a node. There may be one or more nodes on a physical machine (e.g. where there are multiple CPU cores on a machine, there may be one node per CPU core—though not necessarily 1:1).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having computer-executable instructions for causing a computer to perform steps comprising:
accessing build data to analyze future build steps in a build process;
calculating predicted costs for a plurality of components of a later phase of the build process using the build data in at least some fashion; and
making the predicted costs of the components available to a scheduler so the scheduler can use the predicted costs of the components to help determine proper load balancing for the later phase of the build process.

2. The computer-readable medium of claim 1, further having computer-executable instructions for causing a computer to perform steps comprising:
repeating the accessing, calculating, and making steps for other phases of the build process.

3. The computer-readable medium of claim 1, wherein the accessing step is operable to access the build data in a build script that contains details about the build process.

4. The computer-readable medium of claim 1, wherein calculating step is operable to determine a total number of files that are included in the components in the later phase of the build process, and to use the total number to aid in calculating the predicted costs for the components.

5. The computer-readable medium of claim 1, wherein the calculating step is operable to determine total sizes of the files that are included in the components in the later phase of the build process, and to use the total sizes of the files to aid in calculating the predicted costs for the components.

6. The computer-readable medium of claim 1, wherein the calculating step is operable to use the build data to determine what file types are used in the components in the later phase of the build process, and to calculate the predicted costs based upon just those file types used in the later phase.

7. The computer-readable medium of claim 1, wherein the calculating step is operable to use the build data to determine classifications for files that are used in the later phase of the build process, and to assign different weights to files based upon the classifications as part of calculating the predicted costs for the components.

8. The computer-readable medium of claim 7, wherein one of the classifications is based upon CPU intensity.

9. The computer-readable medium of claim 7, wherein one of the classifications is based upon disk intensity.

10. A method for calculating and communicating future cost predictions to a scheduler during a distributed build process comprising the steps of:
during a first phase of a distributed build process, calculating predicted costs for components of a second phase of the distributed build process;
making the predicted costs of components of the second phase available to a scheduler for use by the scheduler in scheduling the second phase of the distributed build process;
during the second phase of the distributed build process, calculating predicted costs for components of a third phase of the distributed build process; and
making the predicted costs of components of the third phase available to the scheduler for use by the scheduler in scheduling the third phase of the distributed build process.

11. The method of claim 10, wherein one of the phases is a prepare phase.

12. The method of claim 10, wherein one of the phases is a generate phase.

13. The method of claim 10, wherein one of the phases is a compile phase.

14. The method of claim 10, further comprising the steps of:
during the third phase of the distributed build process, calculating predicted costs for components of a fourth phase of the distributed build process; and
making the predicted costs of components of the fourth phase available to the scheduler for use by the scheduler in scheduling the fourth phase of the distributed build process.

15. The method of claim 14, wherein one of the phases is a link phase.

16. A method for using predicted cost information to help make a load balancing determination comprising the steps of:
accessing a cost data store to retrieve predicted costs for components included in an upcoming phase in a distributed build process, the predicted costs having been stored in the data store by a cost calculator, the predicted costs having been calculated by the cost calculator upon analyzing build data associated with the upcoming phase;
making a load balancing determination for how to allocate the upcoming phase of the build process among build machines based at least in part upon the predicted costs for the components; and
distributing the build process across build machines based upon the load balancing determination.

17. The method of claim 16, wherein the distributing stage includes putting responsibility for a build of a largest component on one of the build machines.

18. The method of claim 17, wherein the distributing stage further includes distributing remaining components evenly among remaining ones of the build machines.

19. The method of claim 16, further comprising:
repeating the accessing, making, and distributing phases for additional phases of the distributed build process.

20. The method of claim 16, wherein the load balancing determination step considers the predicted costs of the component in combination with other build data to arrive at the load balancing determination.
